(19) United States
(12) Patent Application Publication
(10) Pub. No.: US 2025/0250388 A1
(43) Pub. Date: Aug. 7, 2025

(54) POLYURETHANE FOAMS

(71) Applicant: Dow Global Technologies LLC, Midland, MI (US)

(72) Inventors: Federico La Terra, Ragusa (IT); Paul Cookson, Suffolk (GB)

(73) Assignee: The Dow Chemical Company, Midland, MI (US)

(21) Appl. No.: 18/856,741

(22) PCT Filed: Jun. 26, 2023
(86) PCT No.: PCT/US2023/069061

§ 371 Date: Oct. 14, 2024

(30) Foreign Application Priority Data
Jun. 27, 2022 (IT) 102022000013531

(51) Int. Cl. C08G 18/08; C08G 18/12; C08G 18/48; C08G 101/00; C08J 9/00

(52) U.S. Cl. CPC C08G 18/14; C08G 18/12; C08G 18/4804; C08G 18/4845; C08J 9/0038; C08J 9/0061; C08J 9/0066; C08G 2101/00; C08G 2110/0008; C08G 2110/0058; C08J 2205/06; C08J 2375/08

(57) ABSTRACT

A foam forming composition for making a flexible polyurethane foam comprises a polyol component including one or more polyether polyols having a hydroxyl number from 25 to 100 mg KOH/g, as determined in accordance with ASTM D4274, and having from two to eight hydroxyl groups per molecule, an additive component including ammonium polyphosphate and alkaline earth metal in a weight ratio of from 1.3:1 to 6.5:1, the additive component being present in amount from 6 part by weight to 50 parts by weight, based on 100 parts by weight of the polyol component, and an isocyanate component including one or more aromatic isocyanates. The composition excludes melamine and halogen containing flame retardants.

Embodiments relate to foam forming compositions and flexible polyurethane foams made from such foam forming compositions.

### INTRODUCTION

Polyurethane foams, such as flexible polyurethane foams, find use in comfort applications such as mattresses, cushioning, padding, stuffed or upholstered furniture, etc. (e.g., to provide support and load bearing). Such polyurethane foams typically include flame retardant additive(s). However, users of flexible polyurethane foams, such as consumers and manufacturers of bedding and furniture, have increasingly demanded that such foams be free of certain flame retardant (FR) additives, especially melamine and halogen-based compounds (such as fluorinated flame retardants, chlorinated flame retardants, and brominated flame retardants-including those known in this technology area). Increasingly, regulations have been phasing out use of melamine and halogen containing flame retardant additives.

Even though such flame retardant additives have been widely used in flexible polyurethane foams because they help enable the foams to meet common flammability standards, such as the British Standard BS 5852:2006 (commonly referred to as Crib 5), which require foams to self-extinguish with a specified maximum weight loss test while showing desirable foam mechanical and physical properties, such as high resilience and a low 90% compression set. Alternative flame retardant additives have been proposed, e.g., Publication No. US 2008/0157037 discloses a halogen free polyurethane foam as part of a dryer seal assembly, which includes an intumescent flame retardant additive comprising ammonium polyphosphate (35-45 wt. %), melamine (35-45 wt. %) and pentaerythritol (15-25 wt. %). However, such composition still requires melamine, as such alternative compositions are sought that are both halogen and melamine free, while still exhibiting good physical and mechanical properties.

### SUMMARY

Embodiments may be realized by providing a foam forming composition for making a flexible polyurethane foam that comprises a polyol component including one or more polyether polyols having a hydroxyl number from 25 to 100 mg KOH/g, as determined in accordance with ASTM D4274, and having from two to eight hydroxyl groups per molecule, an additive component including ammonium polyphosphate and alkaline earth metal carbonate in a weight ratio of from 1.3:1 to 6.5:1, the additive component being present in amount from 6 part by weight to 50 parts by weight, based on 100 parts by weight of the polyol component, and an isocyanate component including one or more aromatic isocyanates. The composition excludes (e.g., does not include, avoids the use of, etc.) melamine and halogen containing flame retardants.

### DETAILED DESCRIPTION

In accordance with embodiments, a flexible polyurethane foam may exhibit improved performance with respect to fire resistance without the use of either melamine and/or a halogen-containing flame retardant (FR) additives (e.g., free of fluorine, chlorine, and bromine based flame retardants). For example, it is sought to avoid using trichloropropyl phosphate TCPP. It has been found that an additive component in a foam forming composition that includes (e.g., consists essentially of) ammonium polyphosphate (APP) and alkaline earth metal carbonate (MC) at a ratio of from 1.3:1 to 6.5:1 (e.g., 1.4:1 to 6:1 and/or 1.5 to 4.5:1 and/or 3.5:1 to 4.5:1 and/or 3.8:1 to 4.2:1, etc.) provides flexible polyurethane foams with improved flame retardancy action. Such an additive component may exclude (e.g., be free of) of melamine flame retardants and/or halogen-containing flame retardants). The amount of the additive component in the foam forming composition is based on a total weight of a polyol component in foam forming composition. For example, the additive component may be present in an amount from 6 parts to 50 parts (e.g., 8 to 40 parts) based on 100 parts (total weight) of the polyol component, e.g., inclusive of all polyols in the foam forming composition and exclusive of the weight of any of an isocyanate component, the additive component, water, catalysts, and surfactants. In exemplary embodiments, the additive component consists essentially of ammonium polyphosphate and at least one selected from the group of calcium carbonate, magnesium carbonate, and barium carbonate.

The foam forming composition may further include water (e.g., as a chemical blowing agent) and may optionally include one or more other physical or chemical blowing agents. The foam forming composition may further include one or more catalysts, such as amine and/or tin catalysts (e.g., tertiary amine catalysts). Also, the foam forming composition may include a surfactant, such as a silicone surfactant. In addition, the foam forming composition may include one or more cell openers to help prepare an open cell foam, that is lightweight and flexible and/or one or more chain extenders and/or one or more crosslinkers.

The polyurethane foams according to embodiments may pass the BS 5852 Crib 5 flammability test and/or may pass the UNI 9175 flammability test, achieving a Class 1M rating. Further, inclusion of a polyisocyanate polyaddition (PIPA) polyol in the foam forming compositions may further improve fire resistance performance. In addition, the foam forming compositions may find broad use and enable improved fire resistance in flexible polyurethane foams having a resilience as determined in accordance with ASTM-D3574-16 (2016) of anywhere from 25 to 85%. As used herein, the term “ASTM” refers to publications of ASTM International, Conshohocken, Pa. As used herein the term “UNI” refers to publications of the Italian Organization for Standardization, Milan IT.

The flexible polyurethane foams include foams of both conventional flex and high resilience foams. As used herein, the term “conventional flex” polyurethane foam may refer to such foams that may contain or come from (a) polyether polyols with secondary hydroxyl groups, or primarily secondary hydroxyl groups, such as is found in polyols derived from propylene oxide (PO) and may contain one or more isocyanates in the isocyanate component. As used herein, the term “high resilience” (HR) flexible polyurethane foam may refer to such foams that may contain or come from polyether polyols with primary hydroxyl groups, such as ethylene oxide (EO) groups, and may contain one or more prepolymer made from methylene di (phenyl isocyanate) s or MDI in the (f) polyisocyanate component. The broad formulation flexibility of the foams and foam forming compositions further allows inclusion of additional polyols, such as polyester polyols and/or PIPA polyols.

The polyurethane foam may have a density as determined in accordance with ISO 845 of less than or equal to 100 kg/m³ (e.g., from 10 kg/m³ to 90 kg/m³, from 20 kg/m³ to 70 kg/m³, from 25 kg/m³ to 60 kg/m³, etc.). The flexible polyurethane foams may have a resilience as determined in accordance with the ASTM-D3574-16 (2016) of from 25 to 85%, or at least 30%, or at least 40%, or at least 50%. The flexible polyurethane foam may exhibit one or more, or all, of (i) a passing rating in the Crib 5 British Standard BS 5852:2006 (Crib 5) test; (ii) a Class 1 IM rating in accordance with the UNI 9175 flammability test; (iii) a Crib 5 test, Time to Extinguish test rating of less than 600 seconds, e.g., less than 450 seconds or; (iv) a Crib 5 Weight Loss test rating of less than 60 g. As used herein the term “Crib 5” refers to the upholstery filling test, ignition source 5, British Standard BS 5852:2006, “Methods of test for assessment of the ignitability of upholstered seating by smouldering and flaming ignition sources”, British Standards (BSI), London, UK, 2006.

The flexible polyurethane foams may have a resilience as determined in accordance with ASTM-D3574-16 (2016) of from 25 to 85% or, e.g., 55% or higher for a high resilience foam. Unless otherwise indicated, conditions of temperature and pressure are ambient temperature (21-24° C.), a relative humidity of 50%, and standard pressure (1 atm).

The polyol component of the foam forming composition may include one or more polyether polyols having a hydroxyl number from 25 to 100 mg KOH/g, as determined in accordance with ASTM D4274, and having from two to eight hydroxyl groups per molecule (said in another way having an average hydroxyl functionality from 2 to 8).

The polyether polyols may comprise the reaction product or adduct of at least one initiator having from two to eight hydroxyl functional groups, such as water or propylene glycol or ethylene glycol or glycerol or trimethylolpropane or sorbitol or sucrose, with one or more alkylene oxides, such as ethylene oxide, propylene oxide, or a combination thereof. The one or more polyether polyols may be chosen from (i) a mixed feed polyether polyol having an ethylene oxide (EO) content of from 0.3 to 40 wt. % based on the total weight of all EO and PO in the polyether polyol; (ii) a polyether polyol having a propylene oxide (PO) content of 100 wt. %, based on the total weight of all EO and PO in the polyether polyol; (iii) a propylene oxide (PO) polyether polyol end-capped with from 10 to 25 wt. % ethylene oxide (EO), based on the total weight of all EO and PO in the polyether polyol; or (iv) a polyisocyanate polyaddition (PIPA) polyether polyol dispersion of polyurethane particles in a polyether polyol carrier each polyurethane particle comprising at least two carbamate linkages.

As used herein, the term “hydroxyl number” in mg KOH/g of analyte refers to the amount of KOH needed to neutralize the acetic acid taken up on acetylation of one gram of the analyte material as determined in accordance with ASTM D4274. The term “average hydroxyl number” refers to the weight average of the hydroxyl number of a mixture of hydroxyl functional compounds. For example, a 50/50 mole % mixture of a PIPA polyol having an hydroxyl number of 80 and an all propylene oxide (PO) polyether polyol (ii) having an hydroxyl number of 60 would have an average hydroxyl number of 0.5 (80)+0.5 (60) or (40+30) or 70. As used herein, the term “hydroxyl equivalent weight” or “equivalent weight” or “EW” of a given polyether polyol or polyol refers to calculated value as determined by the equation: EW=56,100/hydroxyl number of a given polyol.

As used herein, the term “hydroxyl functionality” and other like terms, refers to the number of hydroxyl groups in an ideal formula of a given diol or polyol, which is not respective of impurities or variability in the formula. The actual hydroxyl functionality of a given polyol may be lower than the nominal hydroxyl functionality for various reasons known in the art.

As used herein, the term “molecular weight” or “MW” of a given polyether polyol or polyol refers to a calculated value as determined by the equation: MW=(56,100/hydroxyl number)×the nominal hydroxyl functionality of a polyol.

As used herein, unless otherwise indicated, the term “isocyanate index” or simply “index” refers to the ratio of the number of equivalents of isocyanate functional groups to the number of equivalents of active hydrogen, e.g. hydroxyl groups, in a given polyurethane forming reaction mixture, multiplied by 100 and expressed as a number. For example, in a reaction mixture wherein the number of equivalents of isocyanate equals the number of equivalents of active hydrogen, the isocyanate index is 100. As used herein, the term “isocyanate reactive group” refers to an active hydrogen, such as a hydrogen in a hydroxyl group.

As used herein, the term “isocyanate” refers to an isocyanate group containing material having one or more isocyanate functional groups, e.g., a isocyanate-terminated prepolymer, a polyisocyanate, or a biuret, allophanate, isocyanurate, carbodiimide, dimer, trimer, oligomer or polymer thereof made by reaction of an isocyanate with one or more other compounds.

As used herein, the phrase “particle size” or “particle size diameter (PSD)” means the particle size diameter of a given material, as determined by laser light scattering, and is reported as the volume % of the particles in the dispersion having the specified maximum particle diameter. As used herein, the phrase “wt. %” stands for weight percent.

The flexible polyurethane foams may be made from foam forming compositions of a two-component reaction mixture of an isocyanate component and an isocyanate-reactive component that includes (a) the polyol component including one or more polyols such as polyether and/or PIPA polyols, and (b) the additive component including a combination of ammonium polyphosphate (APP) and alkaline earth metal carbonate (MC) in a weight ratio of APP:MC of from 1.3:1 to 6.5:1, (c) potentially other components such as water, one or more catalysts, and one or more surfactants. The foam forming compositions and the flexible polyurethane foams made therefrom are free of melamine and halogen-containing flame retardants. The alkaline earth metal carbonate (MC) may include at least one selected from the group of calcium carbonate, magnesium carbonate, and barium carbonate.

The foam forming compositions may enjoy a wide formulation window and include compositions that form low density, high resilience polyurethane foams, slabstock polyurethane foams of a conventional resilience, featuring improved flame retardant performance. The flexible polyurethane foams may have improved flame retardant performance. The nature of the foam forming composition may determine low or high resilience foam forming. For example, high resilience foams may result from foam forming compositions having more or exclusively primary hydroxyl groups, such as ethylene oxide (EO) groups, in condensed form, and/or in compositions having, for example, methyl di (phenyl isocyanate) (MDI) in condensed form. Meanwhile, conventional resilience foams may contain, in condensed form, all secondary hydroxyl groups, such as propylene oxide (PO) groups, or, for example, PO/EO mixed feed polyether polyols.

The polyol component includes one or more polyether polyols having a hydroxyl number from 25 to 100 mg KOH/g (e.g., 28 to 80 mg KOH/g), as determined in accordance with ASTM D4274, and having from two to eight hydroxyl groups (e.g., two to six) per molecule. The one or more polyether polyols may have a weight average molecular weight from 1100 g/mol to 18000 g/mol (e.g., from 2400 to 15000, from 3000 to 10000, etc.). The polyether polyol compositions may have an equivalent weight per hydroxyl group of greater than 550 (e.g., at least 700, at least 1000, at least 1200, or at least 1500 and may be up to 2250, up to 2000, or up to 1800, etc.).

Such polyether polyols may be formed from an initiator having at least two hydroxyl groups. The nominal hydroxyl functionality or number of hydroxyl groups of each polyether polyol equals the number of hydroxyl groups in the initiator. Suitable initiators may have from two to eight hydroxyl groups (e.g., from 2 to six hydroxyl groups). Suitable polyether polyols useful as the (a) one or more polyether polyols for making flexible polyurethane foams may be formed from co-initiated diol and triol initiators. Initiators may include, e.g., glycerol, erythritol, pentaerythritol, diglycerol, sorbitol, sucrose, sugar alcohols, and other polyhydric alcohols. Examples of diol initiators include ethylene glycol, 1,2-propylene glycol, 1,3-propylene glycol, 1,4-butane diol, diethylene glycol, thiodiethanol, N-methyldiethanolamine and dipropylene glycol. Examples of triol initiators may include glycerol, trimethylolpropane and triethanolamine. Difunctional polyether polyols may be formed from solely diol starters; and, if triol starters are used, then trifunctional polyether polyols may result.

The polyol component may include at least one polyether polyol that has a hydroxyl number from 30 to 40 mg KOH/g.

The (a) polyether polyols in the polyol component of the foam forming compositions may be chosen from any of:
(i) a mixed feed polyether polyol having an ethylene oxide (EO) content of from 1 wt. % to 40 wt. % (e.g., from 5 to 30 wt. %, from 10 to 30 wt. %), and a propylene oxide (PO) content of from 60 to 99 wt. % (e.g., from 70 to 95 wt. %, from 70 to 90 wt. %), based on the total weight of all EO and PO in the polyether polyol (mixed feed polyether polyol (i));
(ii) a polyether polyol having a propylene oxide (PO) content of 100 wt. %, based on the total weight of all EO and PO in the polyether polyol (PO polyether polyol (ii));
(iii) a propylene oxide (PO) polyether polyol end-capped with from 10 to 30 wt. % ethylene oxide (EO), based on the total weight of all EO and PO in the polyether polyol (EO end-capped PO polyether polyol (iii));
(iv) a polyisocyanate polyaddition (PIPA) polyol dispersion of polyurethane and/or polyurethane-urea particles in a polyol carrier (PIPA polyol). For example, the PIPA polyol may be a dispersion of polyurethane and/or polyurethane-urea particles in the carrier polyol, wherein the carrier polyol has an average molecular weight of 200 to 12000 g/mol (e.g., 400 to 6000 g/mol) and an average of at least two hydroxyl groups per molecule.

The polyol component may include mixtures of two or more polyols, such as a mixture of a mixed feed polyether polyol (i) and a (PO) polyether polyol (ii); a mixture of a mixed feed polyether polyol (i) and an EO end-capped PO polyether polyol (iii); or a mixture of a PO polyether polyol (ii) and an EO end-capped PO polyether polyol (iii). Optionally the PIPA polyol. For example, the (a) one or more polyether polyols comprise, in condensed form, (v) a mixture of the (iv) PIPA polyol with any one or more of the polyether polyols (i), (ii), or (iii), and which mixture comprises, in condensed form, from 10 to 99 wt. % (e.g., from, 20 wt. % or more) of the (iv) PIPA polyol. The polyol component may include the PIPA polyol, or a mixture of a (iv) PIPA polyol with a polyether polyol, wherein the mixture has an average hydroxyl number as determined in accordance with ASTM D4274 of from 25 to 100 (e.g., from 28 to 75).

Suitable (a)(iv) (PIPA) polyols for the foam forming compositions may comprise dispersions of polycarbamate particles dispersed in a polyether polyol carrier. Suitable PIPA polyols may be made by via known polymerization in the presence of (d4) one or more polyisocyanates, such as a diisocyanate, of an excess of a (d1) polyether polyol with a (d2) compatible seed polyol, and a (D3) co-reactant polyol, such as in the manner disclosed in US 2014/0051778A1, to Cookson et al. The PIPA polyol dispersions may be made by forming and reacting a reaction mixture under shear to advance the PIPA polyol until the exotherm of the homogeneous dispersion ceases. Thus, (a)(v) PIPA polyols may be the product of a reaction mixture of an excess of (d1) polyether polyol carrier, such as, e.g., one or more propoxylated or oxyethylene end-capped polyether polyols having a molecular weight MW of from 200 to 6000 g/mol, and an average hydroxyl functionality of two or three, with (d2) a compatible seed polyol, and (d3) one or more co-reactant polyols, such as triethanolamine (TEOA) or diethanolamine (DEOA), in the presence of (d4) one or more polyisocyanate (e.g., an aromatic polyisocyanate).

For polyether polyols suitable as (d1) the carrier in a (a)(iv) PIPA polyol may be any known polyether polyol known in the art having two to eight hydroxyl groups and a MW of up to 6000 g/mol. Included are, e.g., the polyether polyols obtained by addition polymerizing at least one oxyalkylene compound of from 2 to 4 carbon atoms, such as ethylene oxide, propylene oxide, and butylene oxide, onto a lower aliphatic polyhydric alcohol having an average of from 2 to 8 hydroxyl groups. Examples of suitable (d1) polyether polyols may include, for example, oxyethylene end-capped polyols, may include a glycerol initiated ethylene oxide end-capped poly (propylene oxide) copolymer triol having from 10 to 19 wt. % of ethylene oxide in the alkylene oxide feed, and an hydroxyl number of from 45 to 80 mg KOH/g.

Suitable amounts of the total (d1) polyether polyol in a PIPA polyol may range from 60 to 99 wt. % (e.g., from 75 to 88.5 wt. %), based on the total weight of the reactants used to make the PIPA polyol (a dispersion), with all total wt. % adding up to 100%. Most of the polyether polyol in a PIPA polyol may act as the carrier phase in the dispersion.

Suitable (d2) compatible seed polyols for use in making a (a)(iv) PIPA polyol may be a PIPA seed formed by reacting at least one (d4) aromatic isocyanate in the presence of an excess of polyol, such as a polyether polyol, in a polyol mixture of (i) any of a propylene oxide polyol, or an oxyethylene end-capped propylene oxide polyol, or a triol initiated polyol of an alkylene oxide containing from 1 to 30 wt. % of ethylene oxide, based on the total weight of the alkylene oxide, and (ii) one or more co-reactant polyol having a nitrogen or phosphorus atom and a molecular weight (MW) of up to 400 (e.g. up to 300), wherein the polyol mixture comprises at least 70 wt. % of the (i) propylene oxide polyol, ethoxylated or oxyethylene end-capped propylene oxide polyol, or triol initiated polyol of an alkylene oxide. To provide for seeds useful for making high resilience foams, the polyol mixture may comprise polyols having at least 45 wt. % (e.g., at least 75 wt. %, at least 80 wt. %, etc.) of hydroxyl groups in the polyol mixture as primary hydroxyl groups. To provide for seed useful for making conventional resilience foams, the polyol mixture may comprise polyols having at least 70 wt. % (e.g., at least 85 wt. %) of hydroxyl groups in the polyol mixture as secondary hydroxyl groups. The isocyanate index may be kept below 100 to keep a PIPA forming co-reactant present in the seed polyol. The at least one polyisocyanate in the reaction used to form the (d2) seed polyol may be used to provide the composition with an isocyanate index of from 50 to less than 100.

Suitable amounts of the (d2) one or more compatible seed may range less than 5 wt. % (e.g., from 2 to 4 wt. %) based on the total weight of the reactants used to make the PIPA polyol, with all total wt. % of reactants to make the PIPA polyol adding up to 100%.

For the PIPA polyol, the (d3) one or more co-reactant polyol may be a diol or triol or oligoether diol having a formula weight of 400 or less, such as triethanolamine (TEOA), or diethanolamine (DEOA). Suitable co-reactant polyols (d3) may include diols, such as dihydric alcohols having a molecular weight from 62 to 400. Examples include alkane polyols such as glycols, like ethylene glycol, propylene glycol, hexamethylene diol, low molecular weight alcohols containing ether groups such as diethylene glycol, triethylene glycol, dipropylene glycol, tripropylene glycol or butylene glycols; high functionality alcohols, such as polyglycerol; and alkanolamines, such as monoethanolamine, diethanolamine, triethanolamine, triisopropanolamine, 2-(2-aminoethoxyethanol), diisopropanolamine, TEOA, DEOA and mixtures thereof.

Suitable amounts of the (d3) one or more co-reactant polyols may range from 0.2 to 6 wt. % (e.g., from 0.5 to 5 wt. %,) based on the total weight of the reactants used to make the (a)(iv) PIPA polyol, with all total wt. % used to make the PIPA polyol adding up to 100%.

For foam forming compositions, the (a)(iv) PIPA polyol may have a solid particle content of from 1 to 40 wt. %, or, from 11.5 to 25 wt. %, or, from 5 to 15 wt. %, based on the total weight of the PIPA polyol. The particles may be uniformly distributed as a dispersion in a polyol carrier and may have a particle size diameter (PSD), as determined by laser light scattering, of 90%, by volume, of the particles in the dispersion having a maximum PSD of from 0.1 to 10.0 μm (e.g., from 0.2 to 5.0 μm, from 0.2 to 2.5 μm).

The polyol carrier in each PIPA polyol may depend on the foam application in which it is used. Lower molecular weight polyols (ii) may find use as a carrier in PIPA polyols suitable for use in making conventional and viscoelastic foams.

The polyol component of the foam forming compositions may further comprise additional polyols, e.g., for a slabstock foam, a glycerol initiated ethylene oxide and propylene oxide mixed feed polyol with a MW of 5000, a 74 wt. % of EO content and a OHn of 33. If used, suitable amounts of the (g) one or more cell openers may range from 0.05 to 1 wt. % (e.g., from 0.1 to 0.6 wt. %), based on the total weight of the polyol component, with all total wt. % adding up to 100.

The polyol component of the foam forming compositions may still further comprise (h) one or more diol extenders. A diol extender may include any diol, for example, ethylene glycol or butanediol. Such (h) diol extenders may be included in the foam forming composition as a reactant which lowers the viscosity of a polyol component and yet ultimately increases the molecular weight of a polyurethane reaction product made from the diol extender. Suitable amounts of the (h) one or more diol extenders, if used, may range from 1 to 8 wt. % (e.g., from 1.5 to 6 wt. %), based on the total weight of the polyol component, with all total wt. % adding up to 100%.

The polyol component of the foam forming composition may further comprise (j) one or more polyester polyols, as may be desirable to improve the mechanical properties of a flexible polyurethane foam made therefrom or its compatibility with another material or substrate. The polyol component of the foam forming compositions may still further comprise (1) one or more crosslinker. A crosslinker may include any triol, or other low MW molecule with hydroxyl functionality higher than 3, for example, glycerine or glycerine derivative obtained by alkoxylation of glycerine with PO to an hydroxyl number of about 620. Such (1) crosslinkers may be included in the foam forming composition as a reactant which lowers the viscosity of a polyol component and yet ultimately increases the molecular weight of a polyurethane reaction product made from the crosslinker. Suitable amounts of the (1) one or more crosslinkers, if used, may range from 1 to 8 wt. % (e.g., from 1.5 to 6 wt. %), based on the total weight of the polyol component, with all total wt. % adding up to 100%.

The isocyanate component foam forming composition comprises one or more isocyanates, e.g., an aromatic isocyanate. Suitable isocyanates for use in the foam forming compositions may be those known in the art, e.g., may comprise an aromatic polyisocyanate, a prepolymer, or a mixture of two or more of these. Examples of useful isocyanates include methylene diphenyl based isocyanates (such as MDI and isocyanate-terminated prepolymers made using MDI) and toluene based isocyanates (such as TDI and isocyanate-terminated prepolymers made using TDI).

In the foam forming compositions, and the methods for making it, suitable amounts of the isocyanate component may range from the amount needed to provide a foam forming composition having an isocyanate index of from 50 to 150 (e.g., from 55 to 125, etc.) The foam forming composition provides for a flexible polyurethane foams that exhibit at least one, or both of (i) a passing rating in the bulk flame Crib 5 British Standard BS 5852:2006 (Crib 5) test; or (ii) a Class 1 IM rating in accordance with the UNI 9175 flammability test. The (b) additive combination is free of halogen containing flame retardants and is free of melamine. Further, the polyol component of the foam forming composition, may include (c) water or at least one blowing agent, or both. Water and blowing agents are generally combined with a polyol component, separate from the polyisocyanate component. Exemplary blowing agents include chemical blowing agents such as water and formic acid, as well as physical blowing agents such as methylene chloride, carbon dioxide, hydrocarbons, hydrofluorocarbons, methylal, and methyl formate. For example, water may be used in an amount from 1.0 to 7.0 wt. % (e.g., 2.5 to 5.0 wt. %.), based on the total weight of the polyol component.

To better drive flexible polyurethane foam formation or polyurethane formation, or both, the isocyanate-reactive component of the foam forming compositions may still further comprise (e) one or more catalysts such as, e.g., a blowing catalyst; a gelling catalyst, such as a metal catalyst; and/or a reactive catalyst, such as an amine catalyst or a tertiary amine. The catalyst maybe a divalent metal salt catalyst, such as, e.g., a zinc salt or zinc fatty acid catalyst, a tin salt or a bismuth salt, and/or a tertiary amine, such as, e.g., a triethylene diamine or bis-dimethylaminoethyl ether. Suitable total amounts of the (e) one or more catalysts may range from 0.01 wt % to 5 wt. % (e.g. from 0.5 to 1.0 wt. %, from 0.01 to 0.2 wt. %, etc.), based on total weight of the isocyanate-reactive component.

The isocyanate-reactive component may include other known additives in the art, such as at least one foam-stabilizers, e.g., that helps stabilize the gas bubbles formed during the foaming process, such as a silicone surfactant; a filler, such as talc; a pigment; a colorant; a reinforcing agent, such as a fiber or microfiber; a biocide; a preservative; an antioxidant; and/or an autocatalytic polyol.

Methods for making the flexible polyurethane foams with improved flame retardant performance may comprise any method for forming a foams using a foam forming composition. The methods may comprise, e.g., forming the isocyanate-reactive component comprising the one or more or a mixture of polyether polyols and the additive combination of ammonium polyphosphate flame retardant and calcium carbonate; and, combining the polyol component with the isocyanate component. The combining may further comprise combining the isocyanate reactive component with isocyanate component to form a reactive mixture. The reactive mixture may then be poured into a mold, such as an open mold or a closed mold. Molding using a closed molding or molding under pressure facilitates formation of higher resilience foams and/or may be free rise. An alternative method may comprise the reaction of the various components such as isocyanate, polyol, catalyst, and additives, that are processed according to continuous slabstock foam production process, typically used for the production on conventional flex foam.

The flexible polyurethane foams may find use in bedding and furniture, or padding, such as in pillows, mattresses and cushions for chairs and sofas, as well as layers in the same, such as mattress toppers in European style mattresses.

### EXAMPLES

The following examples illustrate exemplary embodiments. Unless otherwise indicated, all temperatures are ambient temperatures (21-24° C.), all pressures are 1 atmosphere and relative humidity (RH) is 35%. Notwithstanding that the numerical ranges and parameters setting forth the broad scope of the invention are approximations, numerical values set forth in the specific examples are reported as precisely as possible. Any numerical value inherently contains certain errors necessarily resulting from the standard variation found in their respective testing measurements.

The materials used in the Examples and not otherwise defined, below, are set forth in Table 1, below. Abbreviations used in the examples include: APP: Ammonium polyphosphate; CC: Calcium carbonate; CLD: Compression load deflection; DEOA: Diethanolamine; EO: Ethylene oxide; FR: Flame Retardant Additive; HR: High Resilience; OHn: Hydroxyl Number; PIPA: Polyisocyanate Polyaddition; PO: propylene oxide; SO: Stannous Octoate.

TABLE 1
Materials

| Material | Description |
|---|---|
| Polyol A | Glycerol initiated all propylene oxide polyol with 3000 MW; OHn = 56 |
| Polyol B | Glycerol initiated ethylene oxide capped- propylene oxide polyol with a MW = |
| | 4900 and about 17 wt. % of EO content; OHn = 34 |
| Polyol C | Glycerol initiated propylene/ethylene oxide mixed feed polyol with a MW = |
| | 3500 and about 11 wt. % of EO content; OHn = 47 |
| Polyol D | Glycerol initiated ethylene oxide and propylene oxide mixed feed polyol with |
| | a MW = 5000 and about 74 wt. % of EO content; OHn = 33 |
| Polyol E | Dispersion of glycerol initiated all propylene oxide polyol PIPA particles (20 |
| | wt. % particle solids); OHn = 72 |
| Polyol F | Dispersion of glycerol initiated ethylene oxide capped (18 wt. % EO) - |
| | propylene oxide polyol PIPA particles (20 wt. % particle solids; OHn = 62) |
| Polyol G | Glycerol initiated ethylene oxide and propylene oxide mixed feed polyol with |
| | MW = 7600 and about 61 wt. % of EO content; OHn = 22 |
| Polyol H | Glycerol initiated polyol based on EO-capped propylene oxide with MW = |
| | 4900 and about 14 wt. % of EO content; OHn = 34 |
| DEOA | Diethanolamine |
| Silicone Surfactant 1 | TEGOSTAB ™ B 8715 surfactant, Evonik Industries, Essen, DE (Evonik) |
| Silicone Surfactant 2 | VORASURF ™ DC 5950 surfactant, The Dow Chemical Company, Midland, |
| | MI (Dow) |
| bis(2-dimethyl aminoethyl) | NIAX ™ A-1 catalyst, Momentive Specialty Chemicals, Philadelphia, PA |
| ether catalyst | |
| bis (N,N-dimethyl-3- | POLYCAT ™ 15 catalyst, Evonik |
| amino-propyl) amine | |
| catalyst | |
| N,N,N′-trimethyl-N′- | JEFFCAT ™ ZF 10 catalyst, Huntsman Chemicals, Salt Lake City, UT |
| hydroxyethyl- | |
| bisaminoethylether | |
| Stannous Octoate (SO) | DABCO ™ T9 Catalyst, Evonik |
| Isocyanate 1 | Isocyanate prepolymer from 92.2 weight parts (pbw) of isocyanates as 46 parts |
| | of purified MDI (4,4′-MDI and 2,4′-MDI) and 46.2 weight parts of Polymeric |
| | MDI (viscosity of 200 mPas at 25° C.); and 5.3 pbw of Polyol G and 2.5 pbw of |
| | Polyol H |
| Isocyanate 2 | Toluene Diisocyanate T-80 (TDI), mix of 80 wt. % and 2,4-TDI and 20 wt. % |
| | 2,6-TDI |
| CC | Calcium Carbonate OM 15 AL filler, Avg particle size ~7 μm, Omya Inc., |
| | Florence, VT |
| MgC | Magnesium Carbonate, Avg particular size ~15 μm, Sigma Aldrich |
| BaC | Barium Carbonate, Avg particular size ~5 μm, Sigma Aldrich |
| ZnC | Zinc Carbonate, Avg particular size ~5 μm, Sigma Aldrich |
| NaC | Sodium Carbonate, Sigma Aldrich |
| Ammonium Polyphosphate | EXOLIT ™ AP 422 phosphate, avg. particle size ~20 μm, Clariant AG, |
| (APP) | Muttenz, CH |

In Table 1, above, Isocyanate 1 is a prepolymer formed by reaction of an isocyanate component with a polyol component. The isocyanate component was added to a reactor and brought under stirring to a reaction temperature of about 70° C., under a nitrogen atmosphere. The polyol component (Polyol G and Polyol H) was premixed, then added progressively into the reactor at a speed that was sufficiently low to allow removal of the exotherm generated by the reaction of the isocyanate groups with the hydroxyl groups. After completing the addition of the polyol component, the prepolymer was digested by keeping it under stirring at about 70° C., while monitoring the NCO content in accordance with the method set forth in ASTM D5155. Prepolymer formation was considered complete when the NCO content reached the target NCO value of 30 wt. %, based on the total amount of prepolymer.

Conventional Resilience Open Box Foam Formation: To form the foams shown in Tables 5 and 6, below, free rise foams were formed by hand mixing and casting in a laboratory scale open cardboard box, in a simplified way of mimicking the slabstock flex foam production method. All stages of the foaming process were carried out in a fume cupboard or under a hood. All the chemicals used in the formulation were allowed to equilibrate at room temperature before use. The foams were made using an open top 27 litre cardboard box (30×30×30 cm). In forming the polyol component, the polyols were accurately weighed into a 2.2 liter plastic bucket and the surfactant, water were added to the polyol. Any solid materials were then added slowly to the polyol while hand mixing to avoid lumps. When more then one solid additive was present, these were mixed together prior introduction into the polyol component. Amine catalysts were then introduced into the polyol component. If used, the gelation catalyst stannous octoate (SO) was weighed into a wetted and tared syringe and placed to the side. The required amount of polyisocyanate was weighed in a separate plastic container which was rinsed with isocyanate before determining the tare, and weighing the plastic container after dispensing the polyisocyanate into the open box to compensate for any polyisocyanate remaining in the container after dispensing.

In the hand-mixing to form the polyol component and then a two-component composition, the mixer speed was set at 2000 rpm; and the following mixing procedure was used:
(i) Starting the stopwatch and rise profiling (foam height measurement) software;
(ii) At 5 seconds, start mixing the polyol component with water and surfactants, and adding solid additives and then amine catalysts;
(iv) At 30 seconds, adding the gelation catalyst (SO) into the polyol component;
(v) At 40 seconds, adding the isocyanate (this is taken as to or the time when reaction starts); and
(vi) At 50 seconds, stopping the mixer and pouring the mixture into the box.

The full rise and blow off times were recorded. After 5 minutes, when a foam was fully formed, the foam was transferred to an oven set at 140° C. to further cure it for 5 minutes. The foam was removed from the box and left overnight in the fume hood at ambient temperature to complete reaction. The resulting foams were crushed using a mechanical roller crusher in order to open the internal cells. The physical properties of all of the conventional resilience foams were tested as shown in Table 2, below.

High Resilience Molded Foam Formation: The foams shown in Tables 3, 4A and 4B, below, were made using a Cannon A 40 high pressure molding machine equipped with an FPL mixing head having a 14 mm piston diameter (Cannon USA, Cranberry Township, PA) and preset to the indicated settings. The mold was heated by water recirculation and treated with a water-free release agent. The two-component foam forming mixture was poured into the mold which was then closed while the mixture was allowed to react inside the mold. The resulting foams were then demolded after the below indicated time period. After demolding, the foams were crushed using a mechanical roller to open the internal cells. Molding machine and process settings were:

| Mold size type/size | For 15.1 liter molds, a 45 cm × 45 cm × | |
|---|---|---|
| | 7.5 cm cavity; and for 10.1 liter molds, 45 | |
| | cm × 30 cm × 7.5 cm | |
| Polyol temperature | 25 to 28° | C. |
| Isocyanate | 25 to 28° | C. |
| temperature | | |
| Foam Forming | 300 | g/s |
| Mixture output | | |
| Polyol pressure | 157.9 atm (160 bar) | |
| Isocyanate pressure | 157.9 atm (160 bar) | |
| Mold surface | 48° | C. |
| temperature | | |

| | |
|---|---|
| Demolding time | 5′ |
| Molded pieces crushed | yes |
| Release agent | C₁₁-C₁₂ isoalkanes, <2% aromatic |
| | (ACMOS 37-4463 or ACMOS 37-4477 agent |
| | Acmos Chemie KG, Bremen, DE). |

Test Methods: In the Examples that follow, the following test methods were used. Standard deviations in all data were within acceptable limits.

UNI 9175—Class 1 IM: Small flame test.

BS 5852 Source 5 (Crib 5): In the Crib 5 test, white fabric was applied for cover. Unless otherwise indicated, each result is an average of two tests. Result is overall a “pass” if Self-extinguishing happens within 10 min and foam Weight Loss remains <60 g during the test. If either Crib 5 test results in a Weight Loss of ≥60 g or it fails Self-extinguishing test, the overall result is reported as FAIL.

TABLE 2
Foam Test Methods and Standards

| Test | Standard |
|---|---|
| Flammability test | Crib 5 test/BS 5852 Source 5 |
| | In the case of conventional foams, the |
| | sample foam seating size was 30 × 30 × 7.5 |
| | cm. The rest was as per standard. |
| Flammability test | UNI 9175 - Class 1 IM rating |
| Density (kg/m3) | ISO 845 |
| Compression set 40%, | ASTM D 3574 |
| 75, 90% (%) | |
| CLD at 40% (kPa) | ISO 3386-1 |

In the foams shown in all of Tables 3, 4A, 4B. 5 and 6, below, all materials except the isocyanate(s) comprised part of the polyol component.

TABLE 3
High Resilience Molded foams, with Class
1 IM Flammability Test Results

| | CE-1* | CE-2* | CE-3* | 1 |
|---|---|---|---|---|
| Material or Test | pbw² | pbw² | pbw² | pbw² |
| DEOA | 0.34 | 0.34 | 0.34 | 0.34 |
| Water | 4.83 | 4.83 | 4.83 | 4.83 |
| Polyol B | 94.03 | 94.03 | 94.03 | 94.03 |
| Silicone Surfactant 1 | 0.67 | 0.67 | 0.67 | 0.67 |
| N,N,N′-trimethyl-N′-hydroxyethyl- | 0.13 | 0.13 | 0.13 | 0.13 |
| bisaminoethylether catalyst | | | | |
| bis (N,N-dimethyl-3-amino-propyl) | 1.34 | 0.67 | 1.34 | 1.34 |
| amine catalyst | | | | |
| CC | 0.00 | 26.83 | 5.37 | 2.15 |
| APP | 10.73 | 0.00 | 5.37 | 8.72 |
| Isocyanate 1 | 68.54 | 68.54 | 68.54 | 68.54 |
| Index | 80 | 80 | 80 | 80 |
| Nominal Foam Density (kg/m³) | 60 | 60 | 60 | 60 |
| Wt. % MC + APP in isocyanate- | 10 | 21 | 10 | 10 |
| reactive component | | | | |
| APP/MC weight ratio | NA¹ | 0 | 1 | 4 |
| UNI 9175 - Class 1 IM | Fail | Fail | Fail | Pass |
| Density, core (kg/m³) | 51.6 | 51.9 | 55 | 55.4 |
| CLD 40% (kPa) | 7.4 | 6.7 | 4.7 | 3.3 |
| Compression Set at 90% (%) | 13.7 | 26.8 | 15 | 13 |

*Denotes Comparative Example;
¹Not applicable;
²Pbw = parts by weight.

In Table 3, all foams were made in molds having a size of 45 cm×45 cm×7.5 cm (15.1 liter) and 45 cm×30 cm×7.5 cm (10.1 liter), to make foam samples as specified in each listed test. As shown in Table 3, above, in the high resilience (HR) foams of Comparative Example 1 and 2 (CE-1 and CE-2) containing either APP or CC, both foams fail the Class 1 IM test. The CE-3 foam containing a 1:1 (w/w) additive combination of APP and CC (solids) at 10 wt. % of solids in the isocyanate-reactive component (such that includes the combination of polyol, water, APP, CC and other additives, excluding only the isocyanate component) also fails the Class 1 IM flammability test. Meanwhile, the foam of inventive Example 1, containing a 4:1 (w/w) additive combination blend of APP and CC (solids) at 10 wt. % of solids in the isocyanate-reactive component, passes the Class 1 IM flammability test.

TABLE 4A
High Resilience Foams Comprising a PIPA Polyol²

| | Material or Test | | | | | | | |
|---|---|---|---|---|---|---|---|---|
| | CE-1A* | CE-2A* | CE-3A* | 1A | 2A | 3A | 4A | 5A |
| | Solid Additive | | | | | | | |
| | | | | APP + | APP + | APP + | APP + | APP + |
| | melamine | APP | CC | CC | CC | CC | CC | CC |
| | (pbw) | (pbw) | (pbw) | (pbw) | (pbw) | (pbw) | (pbw) | (pbw) |
| DEOA | 0.34 | 0.34 | 0.34 | 0.34 | 0.34 | 0.34 | 0.34 | 0.34 |
| Water | 4.83 | 4.83 | 4.83 | 4.83 | 4.83 | 4.83 | 4.84 | 4.84 |
| Polyol B | 94.03 | 94.03 | 94.03 | 94.03 | 94.03 | 94.03 | 67.16 | 47.01 |
| Polyol F | 0.00 | 0.00 | 0.00 | 0.00 | 0.00 | 0.00 | 26.86 | 47.01 |
| Silicone Surfactant 1 | 0.67 | 0.67 | 0.67 | 0.67 | 0.67 | 0.67 | 0.67 | 0.67 |
| N,N,N′-trimethyl-N′-hydroxyethyl-bisamino- | 0.13 | 0.13 | 0.13 | 0.13 | 0.13 | 0.13 | 0.13 | 0.13 |
| ethylether catalyst | | | | | | | | |
| bis (N,N-dimethyl-3-amino-propyl) amine catalyst | 0.67 | 1.21 | 0.67 | 1.48 | 1.34 | 1.34 | 1.34 | 1.34 |
| Melamine | 26.83 | 0.00 | 0.00 | 0.00 | 0.00 | 0.00 | 0.00 | 0.00 |
| CC | 0.00 | 0.00 | 26.83 | 5.37 | 6.71 | 8.05 | 5.37 | 5.37 |
| APP | 0.00 | 26.83 | 0.00 | 21.46 | 26.83 | 32.19 | 21.49 | 21.49 |
| Isocyanate 1 | 51.37 | 51.37 | 51.37 | 51.37 | 51.37 | 51.37 | 51.44 | 51.44 |
| Index | 60 | 60 | 60 | 60 | 60 | 60 | 60 | 60 |
| PIPA polyol Particles ¹ (wt. % of total polyol) | 0 | 0 | 0 | 0 | 0 | 0 | 5 | 9 |
| Polyol F wt. % in total polyol component | 0 | 0 | 0 | 0 | 0 | 0 | 21 | 37 |
| Nominal Density (kg/m³) | 60 | 60 | 60 | 60 | 60 | 60 | 60 | 60 |
| Wt. % MC + APP in isocyanate-reactive component | 0 | 21 | 21 | 21 | 25 | 28 | 21 | 21 |
| APP/MC weight ratio | NA³ | NA³ | 0 | 4 | 4 | 4 | 4 | 4 |

*Denotes Comparative Example;
¹ PIPA particles in a Polyol F;
²Formulation amounts are expressed per 100 weight parts of polyol component;
³Not applicable.

TABLE 4B
Test Results for High Resilience Foams Comprising a PIPA Polyol

| | Material or Test | | | | | | | |
|---|---|---|---|---|---|---|---|---|
| | CE-1A* | CE-2A* | CE-3A* | 1A | 2A | 3A | 4A | 5A |
| | Additive Combination | | | | | | | |
| | | | | APP + | APP + | APP + | APP + | APP + |
| | melamine | APP | CC | CC | CC | CC | CC | CC |
| Crib 5 test result (overall) | Pass | Fail | Fail | Pass | Pass | Pass | Pass | Pass |
| Time of extinguish of Crib 5 test (s) | 225 | Fail | Fail | 213.5 | 218 | 215 | 241 | 216 |
| Weight loss for passed Crib 5 test (g) | 24.25 | Fail | fail | 29.8 | 23 | 20 | 33.5 | 29 |
| Density: core (kg/m³) | 53.3 | 54.8 | 53.0 | 54.5 | 56 | 55.1 | 54.4 | 54.9 |
| CLD 40% (kPa) | 2.9 | 3.0 | 2.1 | 1.5 | 2.1 | 2 | 2.4 | 3.6 |
| Compression Set at 90% | 84.0 | 72.4 | 82.3 | 84.2 | 72.8 | 52 | 82 | 85 |
| Compression Set at 75% | 25.5 | 12.2 | 11.2 | 13.6 | 64.9 | 12 | 32 | 61 |

*Denotes Comparative Example.

The foams described in Tables 4A and 4B were made in molds having a size of 45 cm×45 cm×7.5 cm (15.1 liter) and 45 cm×30 cm×7.5 cm (10.1 liter). As shown in Tables 4A and 4B, above, Comparative Example CE-1A comprises melamine at a solids content of 21 wt. % in the isocyanate-reactive component. CE-1A stands as the comparative standard for flammability performance. The foam of Inventive Example 1A having an APP/CC weight ratio of 4 at a solids content of 21 wt. % in the isocyanate-reactive component passed Crib 5 test. Meanwhile, both the foams of Comparative Examples CE-2A and CE-3A, loaded with either APP or CC, respectively, at a solids content of 21 wt. % in the isocyanate-reactive component, failed the Crib 5 test. Further, the foams of Inventive Examples 2A and 3A having an additive combination in a solids content in the amount of, respectively, 25 wt. % and 28 wt. % in the isocyanate-reactive component passed the Crib 5 test. As foam weight loss goes from 29.7 wt. % for Inventive Example 1A to 20 wt. % for Inventive Example 2A, a higher loading of the same inventive additive combination further improves fire resistance. Still further, the foams of Inventive Examples 4A and 5A having an APP/CC weight ratio of 4 at a solids content of 21 wt. % in the isocyanate-reactive component and, further comprising, a PIPA polyol passed Crib 5 test. In addition, the foam of Inventive Example 3A has an improved compression set, evidencing that a high performance foam material can have a higher loading of the additive component.

The foams made in Table 5, below, were made in free rise open top 30 cm×30 cm boxes. As shown in Table 5, below, the foam of Comparative Example CE-1B comprises an open box foam loaded with melamine representing the state of the art. The foams of Comparative Examples CE-2B and CE-3B, comprising foams loaded with either CC or APP individually fail the Class 1 IM flammability test.

In contrast to Comparative Examples CE-2B and CE-3B, the foams in Inventive Examples 1B, 2B, 3B and 4B having the same total additive combination content (19 wt. % solids the isocyanate-reactive component) as the foam of Comparative Example CE-1B all passed the UNI 9175 test with a Class 1 IM rating at an APP/CC weight ratio ranging from 1.5 to 1.86 to 2.57 to 4. Meanwhile, the foams of Comparative Examples CE-4B and CE-5B comprising, respectively, a weight ratio of APP/CC of 0.7 and 9 all fail to pass the UNI 9175 test with a Class 1 IM rating. In addition, the foams of Inventive Examples 1B, 2B, 3B and 4B show an increased compression set at 90% when they contain relatively more APP.

TABLE 5
Open Box Foams having Conventional Resilience and Test Results²

| | Material or Test | | | | | | | | |
|---|---|---|---|---|---|---|---|---|---|
| | CE-1B* | CE-2B* | CE-3B* | CE-4B* | 1B | 2B | 3B | 4B | CE-5B* |
| | (pbw) | (pbw) | (pbw) | (pbw) | (pbw) | (pbw) | (pbw) | (pbw) | (pbw) |
| Polyol A | 47.05 | 47.05 | 47.05 | 47.05 | 47.05 | 47.05 | 47.05 | 47.05 | 47.05 |
| Polyol D | 0.48 | 0.48 | 0.48 | 0.48 | 0.48 | 0.48 | 0.48 | 0.48 | 0.48 |
| Polyol E | 47.53 | 47.53 | 47.53 | 47.53 | 47.53 | 47.53 | 47.53 | 47.53 | 47.53 |
| DEOA | 0.57 | 0.57 | 0.57 | 0.57 | 0.57 | 0.57 | 0.57 | 0.57 | 0.57 |
| Silicone Surfactant 2 | 0.67 | 0.67 | 0.67 | 0.67 | 0.67 | 0.67 | 0.67 | 0.67 | 0.67 |
| Water | 3.71 | 3.71 | 3.71 | 3.71 | 3.71 | 3.71 | 3.71 | 3.71 | 3.71 |
| bis(2-dimethyl | 0.12 | 0.12 | 0.35 | 0.21 | 0.21 | 0.35 | 0.35 | 0.35 | 0.35 |
| aminoethyl) ether | | | | | | | | | |
| catalyst | | | | | | | | | |
| bis (N,N-dimethyl-3- | 0.00 | 0.00 | 0.95 | 0.63 | 0.63 | 0.48 | 0.56 | 0.76 | 0.86 |
| amino-propyl) amine | | | | | | | | | |
| catalyst | | | | | | | | | |
| Stannous Octoate | 0.08 | 0.08 | 0.08 | 0.11 | 0.11 | 0.11 | 0.11 | 0.11 | 0.11 |
| catalyst | | | | | | | | | |
| Melamine | 23.76 | 0.00 | 0.00 | 0.00 | 0.00 | 0.00 | 0.00 | 0.00 | 0.00 |
| CC | 0.00 | 23.76 | 0.00 | 14.26 | 9.51 | 8.32 | 6.65 | 4.75 | 2.38 |
| APP | 0.00 | 0.00 | 23.76 | 9.51 | 14.26 | 15.45 | 17.11 | 19.01 | 21.39 |
| Isocyanate 2 | 44.49 | 44.49 | 44.49 | 44.49 | 44.49 | 44.49 | 44.49 | 44.49 | 44.49 |
| Isocyanate Index | 95 | 95 | 95 | 95 | 95 | 95 | 95 | 95 | 95 |
| Nominal Density (g/L) | 30 | 30 | 30 | 30 | 30 | 30 | 30 | 30 | 30 |
| APP and MC (wt. % | 0 | 19 | 19 | 19 | 19 | 19 | 19 | 19 | 19 |
| isocyanate-reactive | | | | | | | | | |
| component | | | | | | | | | |
| APP/MC weight ratio | NA¹ | 0 | NA¹ | 0.7 | 1.5 | 1.9 | 2.6 | 4 | 9 |
| UNI 9175 - Class 1 IM | Pass | Fail | Fail | Fail | Pass | Pass | Pass | Pass | Fail |
| Density, core (g/L) | 30.8 | 30.8 | 31.8 | 31.1 | 31.1 | 30.8 | 31.8 | 30.6 | 31.7 |
| CLD 40% (kPa) | 3.6 | 4.1 | 3.3 | 3.7 | 4 | 3.3 | 3.9 | 3.1 | 3.4 |
| Comp. set at 90% (%) | 30.1 | 4.2 | 3.3 | 9.8 | 8.8 | 15.6 | 10.4 | 14.4 | 16.6 |

*Denotes Comparative Example;
¹Not Applicable;
²Formulation amounts are expressed per 100 weight parts of the polyol component.

TABLE 6
Open Box Foams having Conventional Resilience and Test Results ⁴

| | Material or Test | | | | | |
|---|---|---|---|---|---|---|
| | 1C | 2C | 3C | 4C | 5C | 6C |
| | (pbw) | (pbw) | (pbw) | (pbw) | (pbw) | (pbw) |
| Polyol A | 94.58 | 75.57 | 75.57 | 59.38 | 47.05 | 0.00 |
| Polyol D | 0.48 | 0.48 | 0.48 | 0.50 | 0.48 | 0.48 |
| Polyol C | 0.00 | 0.00 | 0.00 | 0.00 | 0.00 | 47.05 |
| Polyol E | 0.00 | 19.01 | 19.01 | 34.93 | 47.53 | 47.53 |
| DEOA | 0.57 | 0.57 | 0.57 | 0.60 | 0.57 | 0.57 |
| Silicone Surfactant 2 | 0.67 | 0.67 | 0.67 | 0.70 | 0.67 | 0.67 |
| Water | 3.71 | 3.71 | 3.71 | 3.89 | 3.71 | 3.71 |
| bis(2-dimethyl aminoethyl) ether catalyst | 0.32 | 0.32 | 0.32 | 0.32 | 0.35 | 0.35 |
| bis (N,N-dimethyl-3-amino-propyl) amine | 0.90 | 0.90 | 0.87 | 0.88 | 0.76 | 0.76 |
| catalyst | | | | | | |
| Stannous Octoate catalyst | 0.11 | 0.11 | 0.11 | 0.12 | 0.11 | 0.11 |
| CC | 5.89 | 5.89 | 4.75 | 4.89 | 4.75 | 4.75 |
| APP | 23.56 | 23.56 | 19.01 | 19.57 | 19.01 | 19.01 |
| Isocyanate 2 | 43.73 | 43.73 | 43.73 | 45.91 | 44.49 | 43.73 |
| Index | 95 | 95 | 95 | 95 | 95 | 95 |
| PIPA Particles³ (wt. % of total polyol) | 0 | 4 | 4 | 7 | 9 | 9 |
| Polyol E wt. % in polyol component) | 0 | 15 | 15 | 28 | 38 | 38 |
| Nominal Density (kg/m³) | 30 | 30 | 30 | 30 | 30 | 30 |
| APP and MC (wt. % in isocyanate-reactive | 23 | 23 | 19 | 19 | 19 | 19 |
| component) | | | | | | |
| APP/MC weight ratio | 4 | 4 | 4 | 4 | 4 | 4 |
| UNI 9175 - Class 1 IM | Pass | Pass | Pass | Pass | Pass | Pass |
| % of passed Crib 5 test/BS 5852 (Crib 5) | 0 | 0 | 0 | 50%¹ | 100 | 100 |
| Nr. of tests Crib 5 test/BS 5852 | 2 | 2 | 2 | 2 | 2 | 2 |
| Time of extinguish Crib 5 test (s) | Fail | Fail | Fail | 240 | 183 | 201 |
| Time of Crib 5 test failure (60 g WL) (s) | 228 | 322 | 320 | 300² | | |
| Weight loss passed Crib 5 test (g) | | | | 32 | 27 | 27 |
| Density, core (kg/m³) | — | 35.3 | — | — | 30.6 | 30.5 |
| CLD 40% (kPa) | — | 3.0 | — | — | 3.1 | — |
| Compression set at 90% (%) | — | 13.1 | — | — | 14.4 | — |

*Denotes Comparative Example;
¹2 tests and 1 passed;
²Result from failed test;
³From PIPA polyol (Polyol E);
⁴ Formulation amounts are expressed per 100 weight parts of the polyol component.

The foams in Table 6, above, were made free rise in open top 30 cm×30 cm boxes. All of the Inventive Examples 1C, 2C, 3C, 4C. 5C, and 6C in Table 6 pass the UNI 9175 flammability test with a Class 1 IM rating. All foams comprised a weight ratio of APP:CC of 4. In the Inventive Example 1C, the foam comprises polyol A (100 wt. % propylene oxide units based on total alkylene oxides). The foams in Inventive Examples 2C, 3C, 4C and 5C contain increasing amounts of a PIPA polyol (polyol E) in addition to polyol A, thereby demonstrating that a PIPA polyol, such as in the amount of 30 wt. % or more of all polyols, or, more preferably, in the amount of 40 wt. % of all polyols enables foams to pass more severe flammability tests, such as the Crib 5 test/BS 5852 Source 5. Further, the Inventive Examples 1C, 2C, 3C, 4C and 5C demonstrate that the flame retardant flexible polyurethane foams according to exemplary embodiments can comprise slabstock foams and other flexible foams having a resilience as determined in accordance with ASTM-D3574-16 (2016) of 30 to 55%. Thus, the scope of the embodiments is not limited to high resilience foams.

Referring to Table 7, below, the examples describe foams having different carbonate nature. Inventive Examples, 1D, 2D, and 3D describe foam formulation respectively having either calcium (CC), magnesium (MgC) or barium carbonateas (BaC) as the alkaline earth metal carbonate source. These foam do pass Crib 5 test. However, Comparative Examples CE-1D and CE-2D describe foams having either Zinc (ZnC) or sodium (NaC) carbonate, and these do not pass Crib 5 test.

TABLE 7
Conventional foam formulation for slabstock.

| | 1D | 2D | 3D | CE-1D | CE-2D |
|---|---|---|---|---|---|
| Material or Test | (pbw) | (pbw) | (pbw) | (pbw) | (pbw) |
| Polyol A | 47.05 | 47.05 | 47.05 | 47.05 | 47.05 |
| Polyol D | 0.48 | 0.48 | 0.48 | 0.48 | 0.48 |
| Polyol E | 47.53 | 47.53 | 47.53 | 47.53 | 47.53 |
| DEOA | 0.57 | 0.57 | 0.57 | 0.57 | 0.57 |
| DC 5950 | 0.67 | 0.67 | 0.67 | 0.67 | 0.67 |
| Water | 3.71 | 3.71 | 3.71 | 3.71 | 3.71 |
| bis(2-dimethyl aminoethyl) ether catalyst | 0.35 | 0.35 | 0.35 | 0.35 | 0.35 |
| bis (N,N-dimethyl-3-amino-propyl) amine | 0.76 | 0.76 | 0.76 | 0.76 | 0.76 |
| catalyst | | | | | |
| Stannous Octoate (SO) | 0.11 | 0.11 | 0.11 | 0.11 | 0.11 |
| CC | 4.75 | 0.00 | 0.00 | 0.00 | 0.00 |
| MgC | 0.00 | 4.75 | 0.00 | 0.00 | 0.00 |
| BaC | 0.00 | 0.00 | 4.75 | 0.00 | 0.00 |
| ZnC | 0.00 | 0.00 | 0.00 | 4.75 | 0.00 |
| NaC | 0.00 | 0.00 | 0.00 | 0.00 | 4.75 |
| Exolit AP 422 | 19.01 | 19.01 | 19.01 | 19.01 | 19.01 |
| Isocyanate 2 | 44.49 | 44.49 | 44.49 | 44.49 | 44.49 |
| Index | 95 | 95 | 95 | 95 | 95 |
| Particles* % in (polyol + solid) | 9 | 9 | 9 | 9 | 9 |
| Polyol E % in total Polyol mix | 38 | 38 | 38 | 38 | 38 |
| Nominal Density (g/L) | 30 | 30 | 30 | 30 | 30 |
| Solid** % in (polyol + solid) | 19 | 19 | 19 | 19 | 19 |
| Melamine % of total solid | 0 | 0 | 0 | 0 | 0 |
| MC % of total solid | 20 | 20 | 20 | 20 | 20 |
| APP % of total solid | 80 | 80 | 80 | 80 | 80 |
| APP/MC weight ratio | 4 | 4 | 4 | 4 | 4 |
| Class 1 IM | Pass | Pass | Pass | Fail | Fail |
| % of passed Crib 5 test/BS 5852 Source 5 | 100 | 100 | 100 | 50 | 0 |
| Nr. of tests Crib 5 test/BS 5852 Source 5 | 2 | 2 | 2 | 2 | 2 |
| Time of extinguish Crib 5 test (s) | 183 | 200 | 202 | 220 | |
| Time of Crib 5 test failure (60 g WL) (s) | | | | 315 | 167 |
| Weight loss passed Crib 5 test (g) | 27 | 26 | 29 | 40 | |
| Density, core (g/L) | 30.6 | 34.5 | 34.4 | 34.1 | 32.2 |
| CLD 40% (kPa) | 3.1 | 4.5 | 4.1 | 4.0 | 3.4 |
| Compression set at 90% (%) | 14.4 | 23.3 | 69.0 | 89.0 | 62.2 |

*From Polyol E
**Melamine, mixture of APP + carbonate (CC, MgC, BaC, ZnC or NaC)

Referring to Table 7, the alkaline earth metal carbonates, in particular, magnesium carbonate, calcium carbonate and barium carbonate, enable similar performance in conjunction with APP in comparison to other carbonates.

1. A foam forming composition for making a flexible polyurethane foam, the composition comprising:
a polyol component including one or more polyether polyols having a hydroxyl number from 25 to 100 mg KOH/g, as determined in accordance with ASTM D4274, and having from two to eight hydroxyl groups per molecule;
an additive component including ammonium polyphosphate and alkaline earth metal carbonate in a weight ratio of from 1.3:1 to 6.5:1, the additive component being present in amount from 6 part by weight to 50 parts by weight, based on 100 parts by weight of the polyol component; and
an isocyanate component including one or more aromatic isocyanates;
wherein the composition excludes melamine and halogen containing flame retardants.

2. The composition as claimed in claim 1, wherein the additive component consists essentially of ammonium polyphosphate and at least one selected from the group of calcium carbonate, magnesium carbonate, and barium carbonate.

3. The composition as claimed in claim 1, wherein the weight ratio is from 1.5:1 to 4.5:1.

4. The composition as claimed in claim 1, wherein the amount of the additive component is from 10 parts by weight to 30 parts by weight, based on 100 parts by weight of the polyol component.

5. The composition as claimed in claim 1, wherein the hydroxyl number of one of the one or more polyether polyols is from 30 to 40 mg KOH/g.

6. The composition as claimed in claim 1, wherein the polyol component further includes a PIPA polyol.

7. The composition as claimed in claim 1, wherein the composition further includes water, one or more catalysts, and one or more surfactants.

8. The composition as claimed in claim 1, wherein the foam forming composition has an isocyanate index from 50 to 150.

9. The composition as claimed in claim 1, wherein the flexible polyurethane foam has a density as determined in accordance with ISO 845 of less than 100 kg/m³.

10. The composition as claimed in claim 1, wherein the flexible polyurethane foam exhibits at least one of (i) a passing rating in the British Standard BS 5852:2006 (Crib 5) test and (ii) a Class 1 IM rating in accordance with the UNI 9175 flammability test.
